(19) United States
(12) Patent Application Publication
(10) Pub. No.: US 2011/0188494 A1
(43) Pub. Date: Aug. 4, 2011

(54) DYNAMIC INTELLIGENT DATA ROUTING APPARATUS AND METHOD

(76) Inventors: Robert Johnson, Flower Mound, TX (US); Ambuj Nayar, Colleyville, TX (US); Robert Todd Wallace, Colleyville, TX (US)

(21) Appl. No.: 12/902,339

(22) Filed: Oct. 12, 2010

Related U.S. Application Data
(60) Provisional application No. 61/250,820, filed on Oct. 12, 2009.

(51) Int. Cl. H04L 12/66

(52) U.S. Cl. 370/352

(57) ABSTRACT

A novel method and system for an LCR engine, herein referred to as a Dynamic Intelligent Routing Engine (DIRE) is disclosed that optimizes in real time the routing of data on a communication network. The method and system includes novel hardware architecture and software where routing queries from telecommunication switching equipment is sent to the DIRE. The DIRE responds to the queries by providing an optimized list of termination vendors. The DIRE provides real time or near real time solutions by addressing issues pertaining to mixed and fixed costs routes, control margins, weighted routing parameters, quality routing and other selected information that may affect routing costs.

### CROSS-REFERENCE TO RELATED APPLICATIONS

This application is a continuation of co-pending U.S. Application No. 61/250,820 filed on Oct. 12, 2009, which application is hereby incorporated by reference for all purposes in its entirety and is assigned to the assignee of the present invention.

### STATEMENT REGARDING FEDERALLY SPONSORED RESEARCH OR DEVELOPMENT

N/A

### REFERENCE TO MICROFICHE APPENDIX

N/A

### BACKGROUND OF THE INVENTION

1. Field of the Invention

This invention generally relates to the field of telecommunication and in particular, intelligent routing of data within a network, such as VoIP networks.

2. Description of the Related Art

Currently most Service Providers (SPs), such as PointOne Telecommunications and Excel Communications that terminate voice minutes as part of their service offerings utilize some form of Least Cost Routing (LCR) engine to determine which termination vendor the SP should use to terminate the voice minutes they are offered. SPs that do not utilize an LCR engine to determine which termination vendor (e.g., One Communications Corporation, Paetec Communications, Inc. or any of the SPs above) they should use to terminate the voice minutes they are offered generally do not do so because the volume of voice minutes they are offered is too low to justify the expense of utilizing an LCR engine.

LCR engines typically utilize information from the call itself to attempt to compute the cost to terminate that call over the available termination vendors based on the rates provided by those vendors, then sort the available termination vendors by the computed costs and provide that list to certain switching equipment that will attempt to terminate the voice minutes to the termination vendors in the LCR order. Today, there are 3 basic types of LCR engines available to SPs.

First, Integrated LCR engines are integrated within the switching equipment and perform their LCR functions in real-time as calls pass through switching equipment. While Integrated LCR engines generally provide a best-effort, localized, real-time LCR function that can bring termination vendor rates into the call routing decision, they also face certain limitations, including but not limited to (1) Integrated LCR engines share their execution environment with the switching functions of the switching equipment, limiting their processing power and throughput, (2) Integrated LCR engines require global (worldwide, as generally oppose to information from an adjacent switching equipment) knowledge across multiple pieces of switching equipment, creating a data management challenge that does not scale with the number of pieces of switching equipment and (3) Integrated LCR Engines do not coordinate with other LCR engines resulting in optimization challenges in cost and non-cost routing.

Second, there are standalone LCR engines. Standalone LCR engines are separate from the switching equipment, but still perform their LCR functions in real-time. As calls pass through the switching equipment, the switching equipment queries a Standalone LCR engine, the Standalone LCR engine replies with a sorted list of termination vendors, and the switching equipment attempts to terminate the call to a termination vendor starting with the first and working down the list. While Standalone LCR engines provide a better-effort, globalized, real-time LCR function that can bring termination vendor rates into the call routing decision, they also face a different set of limitations, including but not limited to (1) Standalone LCR engines are decoupled from the switching equipment, reducing the knowledge and information that they can introduce into the LCR function and (2) Standalone LCR engines do not coordinate with the switching equipment resulting in optimization challenges in cost and non-cost routing matters.

A third type of LCR engines is a non-real time LCR engine. Non-real time LCR engines are also separate from the switching equipment, but do not perform their LCR functions in real-time. Instead, non-real-time LCR engines combine termination vendor rates with other information to execute their LCR functions for the purposes of analysis. In some cases, non-real-time LCR engines can produce non-LCR routing tables that can be loaded into the switching equipment. These routing tables do not allow the switching equipment to perform an LCR function in real-time, but do extend the benefits of LCR to that switching equipment. Non-real-time LCR engines may provide a globalized LCR function, but they also face a different set of limitations, including but not limited to the fact that non-real time LCR engines are non-real-time and therefore cannot expose and exploit the ideal, globalized (worldwide and generally beyond an adjacent switching equipment) LCR function into the switching function of the switching equipment.

Thus, current LCR engines cannot provide in real time an ideal global solution, but rather do so after a call is made. In addition, existing LCR engines are limited in their scope to evaluate actual costs or reducing non-cost variables and parameters into cost terms in order to combine them with actual costs to fit them into the sorting function of the LCR engine.

The current systems do not permit termination vendors to optimize profit margins while terminating the voice minutes that are offered. Specifically, termination vendors cannot do any of the following using existing LCR engines (1) Mix fixed-cost and variable-cost routes: Fixed-cost routes cost the same per month regardless of the number of voice minutes terminated over them, which changes the effective per-minute cost in real-time, (2) Control margins directly: Margins are easily computed as price minus cost, but price and cost are often computed differently because the business rules differ between customers and vendors, (3) Weight routing parameters: Routing parameters such as Location Routing Number (LRN) effect different customers and vendors differently, again based on disparate business rules, which effect overall cost, price, and margin, (4) Quality routing: Quality metrics that cannot be reduced to cost cannot be introduced into the LCR function and (5) Selective inclusion: Routing parameters can vary by time-of-day, day-of-week, etc. and those parameters must be available to adjust the routing in real-time.

### BRIEF SUMMARY OF THE INVENTION

A novel method and system for an LCR engine, herein referred to as a Dynamic Intelligent Routing Engine (DIRE) is disclosed that optimizes in real or near-real time the routing of data on a communication network. The method and system includes a novel hardware architecture and software algorithm where routing queries from telecommunication switching equipment is sent to the DIRE. The DIRE responds to the queries by providing an optimized list of termination vendors. The DIRE provides real time or near real time solutions by addressing issues pertaining to mixed and fixed costs routes, control margins, weighted routing parameters, quality routing and other selected information that may affect routing costs.

### BRIEF DESCRIPTION OF THE DRAWINGS

A better understanding of the present invention can be obtained with the following detailed descriptions of the various disclosed embodiments in the drawings, which are given by way of illustration only, and thus are not limiting the present invention, and wherein:

FIG. 1 is a system architecture of the present invention.

FIG. 2 is a diagram of system utilizing an algorithm of the present invention.

FIG. 3 is a flow chart depicting a process of the present invention.

### DETAILED DESCRIPTION OF THE INVENTION

Generally, the present invention involves a method and system for the real time or near real time optimization of data transmission.

Description of DIRE Architecture.

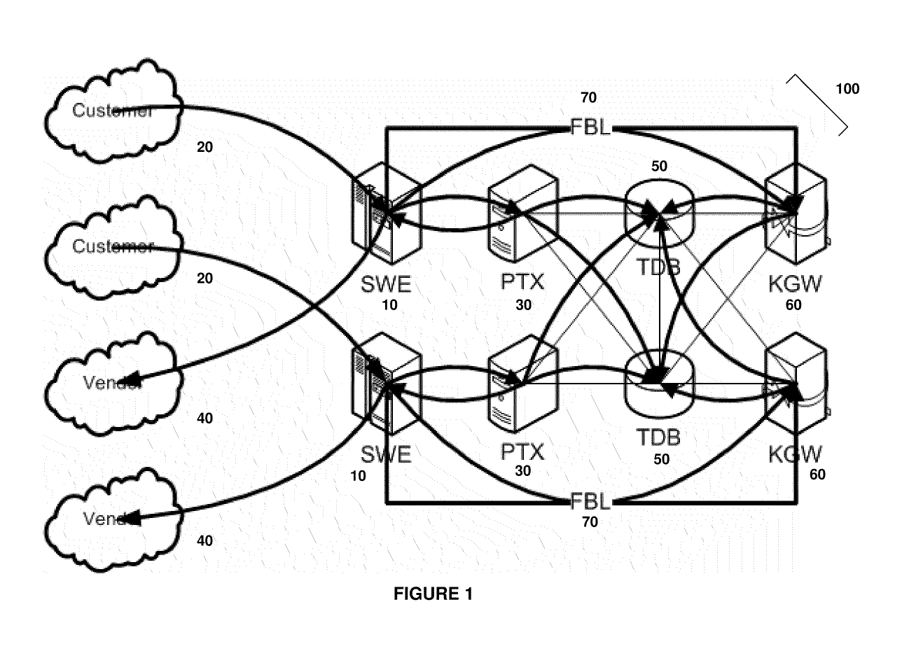

One preferred embodiment of the hardware architecture is illustrated in FIG. 1. The embodiment consists of 5 components as illustrated in FIG. 1 and described below.

Switching Equipment (SWE).

A Switching Equipment (SWE) 10 or telecommunication switch provides the switching of voice minutes offered for termination from the customers who offered them to the termination vendors who will terminate them in a telecommunication system 100. The SWE 10 can be any currently existing SWE, such as, but not limited to (1) Traditional Time Division Multiplexing (TDM) switches, (2) Softswitches (SSWs) and (3) Session Border Controllers (SBCs). The SWE 10 is coupled to the system 100 so that it can query an external routing engine.

The SWE 10 generally receives calls from Customers 20 that comports with signaling protocols the Customers 20 require and the SWE 10 supports, such protocols as, but not limited to (1) Signaling System 7 (SS7), (2) ISDN User Part (ISUP), (3) H.323 and (4) Session Initiation Protocol (SIP).

The SWE 10 is typically configured to trigger on some (or all) Customer 20 calls to initiate a routing query to Protocol Translators (PTXs) 30 (as described in detail below). The routing query utilizes a signaling protocol that supports routing queries and that is unrelated to, but might be the same as, the Customer 20 signaling protocol, such as (1) SS7 Transaction Capabilities Application Part (TCAP), (2) Session Initiation Protocol (SIP) or (3) Enumeration (ENUM).

The PTXs 30 will perform their functions (see description below) and return a response to the SWE 10 utilizing the same signaling protocol that the SWE 10 utilized to initiate the routing query. The SWE 10 may apply a local policy to the routing query response and then iterate through the list of Termination Vendors 40 and attempt to terminate the call to each Vendor 40.

The SWE 10 terminates calls to Vendors 40 utilizing whatever signaling protocol the Vendors 40 require and the SWE 40 supports, which are drawn from the same pool of signaling protocols potentially in use by Customers 20 (see description above). The SWE 10 will record successes and some failures in one or more Call Detail Records (CDRs) (not shown).

Protocol Translators (PTXs).

The Protocol Translators (PTXs) 30 provide the translation of the SWE routing query from the signaling protocol utilized by the SWE 10 (see above) into a Structured Query Language (SQL) utilized by Transaction Databases 50 (TDBs) and the translation of a TDB routing query response from SQL into the SWE routing signaling protocol. The PTXs 30 utilizes a combination of source code and third-party protocol stacks built on existing general-purpose computing platforms.

Once the PTX 30 receives a routing query from the SWE 10, the PTX 30 extracts the relevant data (knowledge and information) from the routing query based on the specific signaling protocol utilized by the SWE 10. The PTX 30 then initiates an SQL query on the TDB 50 containing the knowledge and information, which triggers the TDB 50 to execute an algorithm (the DIRE algorithm). The TDB 50 returns the routing query response to the PTX 30 utilizing SQL, which the PTX 30 then translates back into the original SWE routing signaling protocol and returns the routing query response to the SWE 10.

Translational Databases (TDBs).

Transactional Databases 50 (TDBs) provide both the storage of the relevant data (knowledge and information) provided by Knowledge Gateways 60 (KGWs) (as described below) and the execution of the DIRE algorithm utilizing that stored knowledge and information and the dynamic knowledge and information provided by the PTXs 30 from the original SWE routing query. The preferred embodiment of the TDBs 50 uses SQL code, including the DIRE algorithm, and is built on existing general-purpose database platforms. One skilled in the art would recognize that other software codes could be implemented to perform the database query function.

When a TBD 50 receives a routing query from a PTX 30, that query triggers the execution of the DIRE algorithm (as description in detail below), which draws some of the required knowledge and information from the PTX' s original routing query and the rest of the required knowledge and information from the stored output of the KGWs 60. The KGWs 60 are not part of the real-time call flow, but rather provide their knowledge and information on an asynchronous, near-real-time basis. The TDB 50 customizes the output of the DIRE algorithm based on the SWE 10 that originated the routing query and returns the customized output to the PTX 30 to be inserted into routing query response for the SWE 10.

Knowledge Gateways (KGWs).

Knowledge Gateways (KGWs) 60 provide the collection and analysis of the near-real-time knowledge and information from the SWE 10 via a Feedback Loop 70 (FBL) (as described in detail below) and other sources, mediation (“mediation” is the transformation of data into an intermediate format) of the knowledge and information into a formation for the DIRE algorithm (see below), and uploading of the knowledge and information onto the TDBs 50. The KGWs 60 utilizes source code built on existing general-purpose computing platforms. The KGWs 60 provide knowledge and information for the DIRE algorithm, but do not run any of the DIRE algorithms.

The KGWs 60 collects CDRs and other knowledge and information from the SWE 10 via the FBL and other knowledge and information, such as Local Number Portability (LNP) and Local Calling Area (LCA), from other sources (not shown). The KGWs 60 analyze and mediate all of this knowledge and information into the DIRE algorithm format, then upload tables into the TDBs 50 for the DIRE algorithm to use in real-time.

Feedback Loop (FBL).

A Feedback Loop 70 (FBL) provides the medium and the method for the KGWs 60 to receive the SWE CDRs and other knowledge and information. In one embodiment, the FBL 60 medium is a link or network that supports communication based on the Internet Protocol (IP), provides an IP communication path between the IP addresses associated with the SWE 10 and the KGWs 60, and permits the IP-based communication protocol between those IP addresses, such as, but not limited (1) File Transfer Protocol (FTP), (2) Secure FTP (SFTP), (3) Secure Shell (SSH), (4) Secure Copy (SCP) or (5) Telnet.

The SWE 10 can push this knowledge and information to the KGWs 60 or the KGWs 60 can collect this knowledge and information from the SWE 10 via a pull method. Regardless of the method, the FBL 70 does not participate in the routing query, only the post-routing knowledge and information transfer from the SWE 10 to the KGWs 60.

Description of DIRE Algorithm

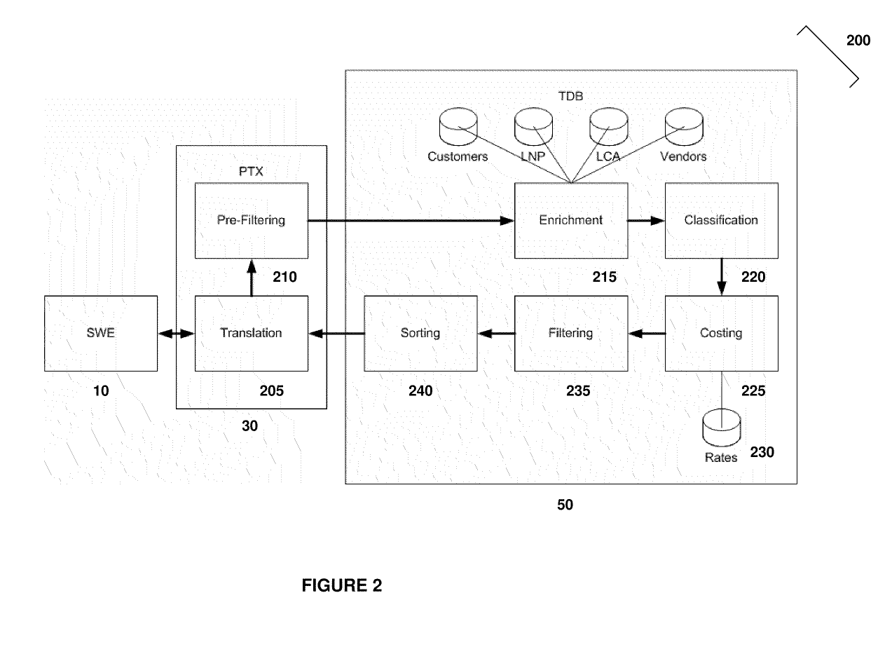

In addition to the DIRE architecture, a DIRE algorithm, as illustrated in FIG. 2 provides real-time, multivariable routing to terminate the offered voice minutes. The preferred embodiment of the DIRE algorithm 200 is a vector-based algorithm that consists of 5 stages as description below:

Translation.

A translation function 205 of the PTXs 30 converts the routing query initiated by the SWE 10 into a set of call parameters based on the routing signaling protocol utilized by the SWE 10. The Translation 205 function passes the entire list of call parameters to a Pre-Filtering function 210.

Pre-Filtering.

The Pre-Filtering function 210 occurs in the PTXs 30 and is not part of the DIRE algorithm, but is needed for its accurate and swift execution. During the Pre-Filtering stage 210, the PTXs 30 extract the DIRE call parameters from the call parameters in the SWE 10 routing query. Typically these will be (1) Calling Party Number (CgPN), (2) Called Party Number (CdPN), (3) Customer ID (could be an IP address, Fully-Qualified Domain Name (FQDN), SS7 Point Code (PC) and Sub-System Number (SSN), or other identifying call parameter). Once the PTX 30 has performed the Pre-Filtering, it can initiate a SQL query containing the pre-filtered call parameters that will trigger the DIRE algorithm on the TDB 50.

Enrichment.

An Enrichment stage 215 is the first stage of the DIRE algorithm and occurs in the TDBs 50. During the Enrichment stage 215, the TDBs 50 query several internal tables and use the data to extend the provided call parameters from point data to data vectors (one each for CgPN, CdPN, and Customer). The DIRE algorithm draws on LNP and LCA data in this stage to populate several parameters in the CgPN and CdPN vectors, including, but not limited to (1) LRN, (2) SPID, (3) Rate Center, (4) LATA, (5) State, (6) OCN or (7) Cluster.

The DIRE algorithm draws on provisioned and SWE 10 knowledge and information to enrich the Customer vector, including, but not limited to (1) Response Vector (map of response maps to response codes), (2) Approved/Blocked Vendor List (list of vendors that are or are not permitted for this Customer), (3) Local Calling Plans or (4) Business Rules.

Classification.

A Classification stage 220 of the DIRE algorithm compares the CgPN and CdPN vectors to determine the classification of the call, which is carried forward in the DIRE algorithm as a vector (Classification vector) containing, but not limited to (1) Intra/InterLATA, (2) Intra/InterState, (3) Locall (based on local calling plan 1) or (4) International.

Costing.

A Costing stage 225 of the DIRE algorithm compares the Classification vector from the Classification stage 220 and the enriched CdPN vector from the Enrichment stage 215 against Rate tables 230 to determine all possible termination vendor options and their associated rates. These termination vendors 40 might include settlement-based and settlement free peering partners.

Filtering.

A Filtering stage 235 in the DIRE algorithm filters the list of termination vendors based on the Approved/Blocked Vendor list and the Customer Business Rules, including performance and margin minimums. The resulting list of termination vendors 40 will generally be acceptable to both the Customer and the SP.

Sorting.

A Sorting stage 240 is the final stage in the DIRE algorithm, during which the TDB 50 sorts the list of termination vendors 40 determined in the Filtering stage based on their associated costs determined during the Costing stage 225, returning a sorted list of acceptable termination vendors 40.

Translation.

The Translation function 205 of the PTXs 30 converts the sorted list of termination vendors 40 provided by the TDBs 50 from the DIRE algorithm into a routing query response in the signaling protocol utilized by the SWE 10 to initiate the original routing query.

There are many advantages to the present invention. The present invention provides mix fixed-cost and variable-cost routes: The Costing stage 225 of the algorithm utilizes costs of any kind (fixed, per minute, tiered, capped, bilateral, etc.) and reduce them to comparable costs in real-time.

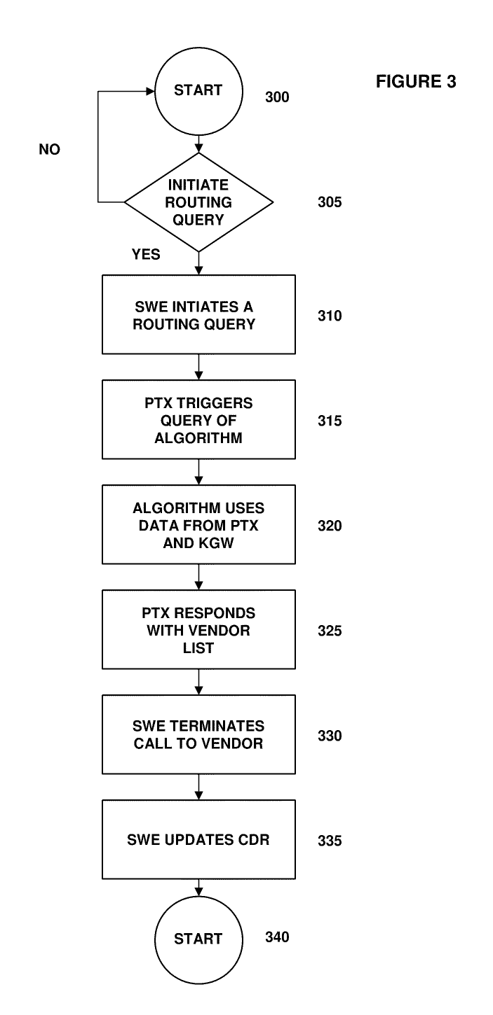

FIG. 3 depicts a flow chart of an exemplary process of one embodiment of the present invention. The process starts at step 300. A decision is made to initiate a routing query at step 305 where the process returns to step 300 if a query is not initiated. If a query is initiated, then the process proceeds to step 310 where the SWE 10 initiates a routing query to the PTX 30. The PTX triggers a query of the DIRE algorithm at step 315. At step 320, the DIRE algorithm uses data from PTXs 30 and TDBs 50. The PTXs 30 responds to the SWE 10 with a vendor list at step 335. At step 300, the SWE 10 terminates call to the vendors 300. At step 335, the SWE 10 updates the call's CDR and the process terminates at step 340.

The present invention controls margins directly by using the Customer Business Rules where the algorithm can adjust to the disparity between Customer pricing and Vendor costing in real-time.

The present invention addresses quality routing by utilizing the FBL 70 wherein the invention can collect network-wide quality and performance data and inject that data into the routing process during the Filtering stage of the DIRE algorithm.

The present invention addresses selective inclusion wherein during the Enrichment 215 and Costing 225 stages, external parameters like Time of Day or Day of Week can be included in the generation of the various vectors utilized by the DIRE algorithm.

The present invention addresses weight routing parameters by combining the Enrichment 215 and Costing 225 stages of the DIRE algorithm and adjusts the parameters utilized to determine cost, price, margin, etc. based on the Customer Business Rules.

The foregoing disclosure and description of the invention are illustrative and explanatory thereof, and various changes in the details of the illustrated apparatus and system, and the construction and the method of operation may be made without departing from the spirit of the invention.

We claim:

1. A system for routing calls through a telecommunication network, comprising:
a switch for receiving and sending calls from a plurality of first users to a plurality of end users;
a processor coupled to the switch;
said switch transmits a request formatted in a certain protocol to the processor;
said processor is coupled to a database wherein the database includes records;
said processor receives the request and provides a list from the records to said switch using the certain protocol; and
said switch receives the lists and sends to the call to a certain end user.

2. The system of claim 1, wherein the certain protocol is SS7.

3. The system of claim 1, wherein the certain protocol is Session Initiation Protocol.

4. The system of claim 1, wherein the certain protocol is Enumeration .

5. The system of claim 1, wherein the processor receives the request and provides the list to the switch in real time.

6. A system for routing calls through a telecommunication network, comprising:
a switch for receiving and sending calls from a plurality of first users to a plurality of end users using a first certain protocol;
a processor coupled to the switch in the telecommunication network;
said switch transmits a request formatted in a second certain protocol to the processor;
said processor receives the request and provides a list to said switch using the second certain protocol; and
said switch receives the lists and sends the call to a certain end user.

7. The system of claim 6, wherein the first certain protocol is a SS7 protocol and the second certain protocol is an Enumeration protocol.

8. A method for providing least cost routing information in real time to a telecommunication switch in a telecommunication network, comprising the steps of:
accessing a first call request from a first user on the telecommunication network;
querying a database based on the first call request for routing information;
updating a table to include characteristics of the telecommunication network;
generating a list for routing the call to an end user in the telecommunication network; and
using the table for use in a second call request.

9. The method of claim 8, wherein the call request is formatted under an SS7 protocol.

10. The method of claim 8, wherein the call request is formatted under an Session Initiation protocol.

11. The method of claim 8, wherein the call request is formatted under an Enumeration protocol.
